(19) United States
(12) Patent Application Publication
(10) Pub. No.: US 2023/0405607 A1
(43) Pub. Date: Dec. 21, 2023

(54) DEVICE AND METHOD FOR CONTINUOUSLY SEPARATING FLOWABLE MATERIALS OF DIFFERENT DENSITY IN A SUSPENSION

(71) Applicant: Alfa Laval Corporate AB, LUND (SE)

(72) Inventor: Johannes BIEGEL, Dillingen (DE)

(73) Assignee: Alfa Laval Corporate AB, LUND (SE)

(21) Appl. No.: 18/034,846

(22) PCT Filed: Oct. 27, 2021
(86) PCT No.: PCT/EP2021/079860

§ 371 Date: May 1, 2023

(30) Foreign Application Priority Data
Nov. 2, 2020 (DE) 10 2020 128 804.2

(51) Int. Cl. B04B 3/04; B04B 9/02; B04B 9/10; B04B 11/02; B04B 13/00

(52) U.S. Cl. CPC B04B 3/04; B04B 9/02; B04B 9/10; B04B 11/02; B04B 13/00

(57) ABSTRACT

A device for continuously separating flowable materials of different densities of a suspension includes: a drum that is rotatably supported about an axis of rotation, that is rotatable about the axis of rotation by a drum motor, and that surrounds a hollow space; a screw conveyor that is rotatably supported about the axis of rotation and is at least partially arranged in the hollow space and that is rotatable about the axis of rotation by a screw conveyor motor; an inflow pipe for supplying the suspension to the hollow space, wherein the drum has an outflow for the removal of a centrate acquired from the suspension from the hollow space; and the outflow section has a free jet section in which the centrate forms a free jet; and a measurement device by which the transmission and/or the reflection of the centrate in the free jet section can be contactlessly determined.

The present invention relates to a device for continuously separating flowable materials of different densities of a suspension The invention moreover relates to a corresponding method.

Such devices are typically configured as a so-called screw centrifuge, also called a decanter centrifuge, and are inter alia used in sewage sludge treatment in sewage treatment plants. The devices comprise a partially cylindrical, partially conical horizontally rotating drum that surrounds a hollow space and a screw conveyor arranged in the hollow space. The rotational drum speed determines the amount of the centrifugal acceleration in the device. A rotational speed difference is set between the drum and the screw conveyor. This is necessary to remove the solid particles, that are contained in the suspension and that are deposited on the inner surface of the drum wall, via the conical part of the device. The liquid phase (centrate) acquired from the suspension in this manner exits the drum at the oppositely disposed end.

The rotational speed difference determines the speed or the mass flow at or by which the solids are conveyed out of the device and thus the dwell time of the solids in the drum. The lower the dwell time, the smaller the water content in the solid phase. The conveying torque of the screw conveyor is analogous to the solid filling of the drum and is automatically adapted via the rotational speed difference in modern decanter centrifuges. The minimal rotational speed difference is bounded by a maximum permitted conveying torque. In addition, the screw conveyor has to remove at least as many solids as are supplied to the device; the excess portion of the solids otherwise enters into the centrate.

An effective phase separation is frequently only possible if so-called flocculation agents, that are in particular formed as polymers, are added to the inflowing suspension. The flocculation agents exert an influence on the flock size and consequently on the deposition speed and the deposition behavior of the solids in the centrifugal field. If the deposition speed is too low, the solids cannot be deposited on the wall within the short dwell time of the liquid phase in the device and are partially carried out with the centrate. In addition, flocculation agents influence the agglomeration of the solids at the drum wall and thus also influence the torque of the screw conveyor and the dry substance content of the removed solids.

The complex optimization object in the separation of flowable materials of different densities, for example on a sewage sludge dewatering using decanter centrifuges, with respect to the settable parameters of the flocculation agent amount and the rotational speed difference comprises achieving a dry substance content in the solid phase that is as high as possible and a dry substance content in the liquid phase that is as small as possible on a simultaneously economic use of the flocculation agents during the entire dewatering process.

Since the dwell time of the solids in the device is relatively large, the dry substance content of the exiting solid phase only represents the conditions in the device with a substantial time delay. In addition, no reliable continuously working dry substance measurements are available for the solid phase. The quality of the centrate is suitable as a measured variable for the optimum operation of the device due to its very short dwell time.

The exiting centrate is frequently acted on by small air bubbles or gas bubbles that are due to the strong eddies in the device and the frequently present surface active ingredients of the flocculation agents. Conventional cloudiness measurements recognize included air bubbles as solid particles and therefore work unreliably without a complex degassing of the centrate.

The exiting centrate additionally has a great tendency toward film formation on surfaces with media contact. Magnesium ammonium phosphate (MAP) above all produces great difficulties in communal sewage purification. The substance tends toward encrusting and can clog whole pipework system over time. The lenses of optical measurement systems with media contact can in particular be coated within a very short time and have to be cleaned in a very laborious manner to deliver reliably reproducible measurement results.

In DE 10 2005 054 504 B4, a cloudiness measurement, not described in any more detail, of a degassed partial flow of the centrate is used as a regulation variable for the metering of the flocculation agents and/or the rotational speed of a flocculation agent mixing device.

In DE 69 129 937 T2, a method is disclosed that radially irradiates diffuse light into the non-degassed centrate in a sample chamber and uses the light reflected by air bubbles and/or solids to readjust the metering of the flocculation agents. The measurement cell with media contact has a device for cleaning the light permeable surfaces.

A device is known from DE 10 2015 105 988 B3 in which a contactlessly working object sensor (photographic camera) is attached in the liquid outflow of the device. The purity of the centrate is regulated by the regulation variables of rotational speed difference, conveying power of the feed pump, or conveying power of the metering pump for the flocculation agent using predefinable desired values for the regulation variables of grayscale values, color values, brightness values, or contrasts.

DE 10 2006 050 921 discloses a device in which the conveying power of the metering pump for the flocculation agent is regulated using a reflection measurement.

DE 10 2010 047 046 A1 discloses a method that regulates the flocculation agent amount using an optical device on the basis of schlieren photographic effects in the centrate.

Various measurement techniques, in particular for the contactless measurement of different parameters, are disclosed in EP 1 241 464 B1, U.S. Pat. Nos. 3,309,956 A, 5,400,137 A, 5,489,977 A, EP 0 775 907 B1 and DE 38 32 901 C2.

It is the underlying object of an embodiment of the present invention to provide a device and a method for continuously separating flowable materials of different densities of a suspension that permit the separation result acquired therefrom to be optimized and monitored.

This object is achieved by the features specified in claims 1 and 7. Advantageous embodiments of the invention form the subject matter of the dependent claims.

An embodiment of the invention relates to a device for continuously separating flowable materials of different densities of a suspension comprising
a drum that is rotatably supported about an axis of rotation, that is rotatable about the axis of rotation by a drum motor, and that surrounds a hollow space;
a screw conveyor that is rotatably supported about the axis of rotation and is at least partially arranged in the hollow space and that is rotatable about the axis of rotation by a screw conveyor motor;
an inflow pipe for supplying the suspension to the hollow space, wherein
   the drum has an outflow for the removal of a centrate acquired from the suspension from the hollow space; and
   the outflow has a free jet section in which the centrate forms a free jet,
and a measurement device by which the transmission and/or the reflection of the centrate in the free jet can be contactlessly determined.

As initially mentioned, the quality of the centrate is suitable as a measured variable for the optimum operation of the device.

The air bubbles included in the centrate are not a disadvantage in accordance with the invention on the determination of the transmission and/or reflection carried out contactlessly on the free jet, inter alia because the change of the transmission and/or the reflection and no values that are absolute in this respect are used in the optimization, which will be looked at in more detail further below. The device configured as a decanter centrifuge can also be optimally operated on a change of the composition of the suspension with reference to the measurement of the transmission and/or of the reflection without a control or a regulation based on absolute values being necessary. Since only the changes of the transmission and/or of the reflection are taken into account, a calibration for the generation of measured variables of affected measurement units can be dispensed with. The tendency of the centrate toward film formation on surfaces with media contact has no influence on the measurement due to the determination of the transmission and/or of the reflection at the free jet.

In accordance with a further embodiment, the outflow is divided into a first outflow section and into a second outflow section, with the free jet section being arranged in the second outflow section. The arrangement of the free jet section in the second outflow section makes it possible to use a representative partial flow for the determination of the change of the transmission and/or of the reflection. The volume flow can therefore be adapted such that the determination of the transmission and/or of the reflection can be optimally carried out without the main volume flow of the centrate through the first outflow section having to be adapted to the determination of the transmission and/or of the reflection. The throughput of the device therefore remains largely unchanged.

In a further developed embodiment, the measurement device can have at least two light sources and at least one light receiver, or at least one light source and at least two light receivers: A transmitted light measurement can be carried out with simple means to determine the transmission and/or a reflected light measurement can be carried out to determine the reflection.

In a further developed embodiment, the measurement device can have at least one transducer that outputs an indication signal when the change of the determined transmission and/or of the determined reflection exceeds or falls below a specific value. It is not absolutely necessary that the device is operated in a fully automated manner. In not a few cases, the device is monitored by a team of employees of the operator that changes specific operating parameters in dependence on the current status of the device. The possibility of providing the team of employees with an indication signal when the change of the determined transmission and/or of the determined reflection exceeds or falls below a specific value supports the team in initiating corresponding countermeasures in good time to be able to operate the device optimally or close to the optimum and thus economically.

In a further embodiment, the measurement device can interact with a control unit by which the drum motor and/or the screw conveyor motor are controllable in dependence on the change of the determined transmission and/or of the determined reflection. Optimization algorithms can be stored on the control unit so that the device can be operated optimally in an automated manner or close to the optimum and thus economically. The rotational speed difference can in particular be optimally set. It must be pointed out at this point that the term “control unit” is not to be understood such that the algorithms carry out a control of the device. An optimization is rather carried out.

A further developed embodiment is characterized in that the device comprises
a feed pump for conveying the suspension into the hollow space through the inflow pipe; and
a metering pump for conveying a flocculation agent into the hollow space, wherein
the feed pump and/or the metering pump are controllable by the control unit in dependence on the determined transmission and/or on the determined reflection.

The flocculation agent amount can also be optimized in addition to the rotational speed difference to avoid an under- or overmetering. On undermetering, the suspension is not fully separated so that the centrate has an increased solid portion. On overmetering, a portion of the flocculation agent remains unused and is removed via the centrate. Corresponding algorithms can also be stored on the control unit for this purpose so that the device can also be operated in an automated manner at or close to the optimum with respect to the flocculation agent.

The object is likewise achieved by a method of continuously separating flowable materials of different densities of a suspension using a device in accordance with one of the preceding claims comprising the following steps:
supplying the suspension to the hollow space through the inflow pipe;
rotating the drum about the axis of rotation by means of the drum motor;
rotating the screw conveyor about the axis of rotation by means of the screw conveyor motor;
removing the centrate acquired from the suspension from the hollow space through the outflow, with the centrate forming a free jet in the free jet section; and
contactlessly determining the transmission of the centrate and/or the reflection by means of the measurement device in the free jet section.

The technical effects and advantages that can be achieved with the proposed method correspond to those that have been discussed for the present device. In summary, it must in particular be pointed out that the tendency of the centrate toward film formation on surfaces with media contact has no influence on the measurement due to the determination of the transmission and/or of the reflection at the free jet.

In a further embodiment, the method comprises the following steps:
rotating the drum about the axis of rotation at a first rotational speed by means of the drum motor;
rotating the screw conveyor about the axis of rotation at a second rotational speed by means of the screw conveyor motor;
changing the rotational speed difference by means of the control unit in dependence on the change of the determined transmission and/or of the determined reflection.

As already mentioned, the rotational speed difference plays an important role for the optimum and economic operation of the device. In accordance with this embodiment of the method, the automated operation of the device is possible at or close to the optimum.

A further developed embodiment of the method specifies the following steps:
conveying a flocculation agent amount into the hollow space by the metering pump;
changing the flocculation agent amount by controlling the metering pump by means of the control unit in dependence on the change of the determined transmission and/or of the determined reflection.

The flocculation agent amount also plays an important role for the optimum and economic operation of the device. In accordance with this embodiment of the method, the automated operation of the device is possible at or close to the optimum. Over- or undermetering of the flocculation agent can in particular be avoided.

In accordance with a further embodiment, the method comprises the following steps:
conveying a suspension into the hollow space by the feed pump; and
changing the suspension amount by controlling the feed pump by means of the control unit in dependence on the change of the determined transmission and/or of the determined reflection.

This embodiment of the method is in particular suitable when the flocculation agent amount is kept constant. The case may occur that the metering pump is not controllable by means of the control unit. To be able to economically operate the device in this case, the optimization is carried out by means of the suspension amount and the feed pump.

According to a further developed embodiment, the method comprises at least one of the following steps:
detecting a reduction of the undermetering (dropping of the solid content) in the centrate on a relative increase of the transmission and the reflection; or
detecting an increase in the undermetering (increasing of the solid content) in the centrate on a relative drop of the transmission and the reflection; or
detecting an increase in the overmetering of the flocculation agent on a relative drop of the transmission and a relative increase in the reflection; or
detecting a reduction of the overmetering of the flocculation agent on a relative increase of the transmission and a relative drop of the reflection.

As the flocculation agent amount increases, the transmission measured at the free jet of the centrate increases up to a relative maximum due to a dropping solid content. The centrate has the relatively smallest solid content in the relative maximum of the transmission. If more flocculation agent is added, the transmission drops again. The repeated drop in the transmission T is due to a clouding of the centrate due to excess flocculation agent and the bubble formation in the centrate that occurs to an increasing degree on an overmetering of the flocculation agent due to surface active substances in the flocculation agents, in particular with polymers. The flocculation agent that is added in the relative maximum represents the economically most favorable flocculation agent amount with the minimal achievable solid content in the centrate.

The reflection measured at the free jet of the centrate has, in contrast with the transmission, a monotonically increasing curve as a function of the flocculation agent amount. The reflection increases up to the optimum flocculation agent amount since the free jet of the centrate becomes brighter and brighter due to the decreasing solid content. The reflection increases again above the optimum flocculation agent amount. This is due to the increasingly milky white coloring of the centrate due to excess flocculation agent and the increasingly occurring bubble formation and the reflection of the light at these bubbles associated therewith.

If the device is operated with a constant flocculation agent amount and a constant suspension volume flow, but the composition of the supplied suspension and thus also the required flocculation agent vary over time, the cause for the change cannot be clearly determined from a resulting change of the transmission alone or from a change of the reflection alone. A drop in the transmission means either an increase in the solid content of the centrate or an increase in the overmetering of the flocculation agent. An increase in the transmission means either a drop in the solid content of the centrate or a drop in the overmetering of the flocculation agent.

A drop in the reflection means either an increase in the solid content of the centrate or a drop in the overmetering of the flocculation agent. An increase in the reflection means either a drop in the solid content of the centrate or an increase in the overmetering of the flocculation agent.

If both the reflection and the transmission are evaluated, the cause of the changes of both values can be clearly determined during the ongoing process. Which measures have to be taken to be able to return the operating state of the device to the optimum is immediately known. These dependencies can accordingly be used to optimize the metering of the flocculation agent.

In accordance with a further developed embodiment, the method comprises the following steps:
minimizing the rotational speed difference until
the solid content in the centrate does not increase or only increases within predefinable limits; and/or
the maximum permitted conveying torque of the screw conveyor (22) is not exceeded.

A minimization of the rotational speed difference increases the economy of operation of the device. As the rotational speed difference drops, the dwell time of the solids in the hollow space and the conveying torque of the screw conveyor increase and the water content of the solid phase thus drops. In this embodiment of the method, the rotational speed difference is minimized while taking account of the conditions of the solid content of the centrate and/or the maximum permitted conveying torque.

The following steps are carried out in a further embodiment:
optimizing the flocculation agent amount using the relative change of the transmission and/or the relative change of the reflection; and/or
optimizing the rotational speed difference using the relative change of the transmission and/or the relative change of the reflection and/or the maximum permitted conveying torque.

As initially mentioned, the rotational speed difference and the flocculation agent amount represent two major parameters for the optimum operation of the device. In this embodiment of the method, not only the optimum operating state for the device can be found, at least for these two parameters, but the device can also be very quickly returned to the optimum operation state on changes, in particular in the composition of the suspension. The optimum operating state can therefore be continuously monitored. Differences from the optimum operating state can be recognized and corrected in real time. If both parameters are optimized, the flocculation agent amount is optimized first before the rotational speed difference is optimized.

Exemplary embodiments of the invention will be explained in more detail in the following with reference to the enclosed drawings. There are shown

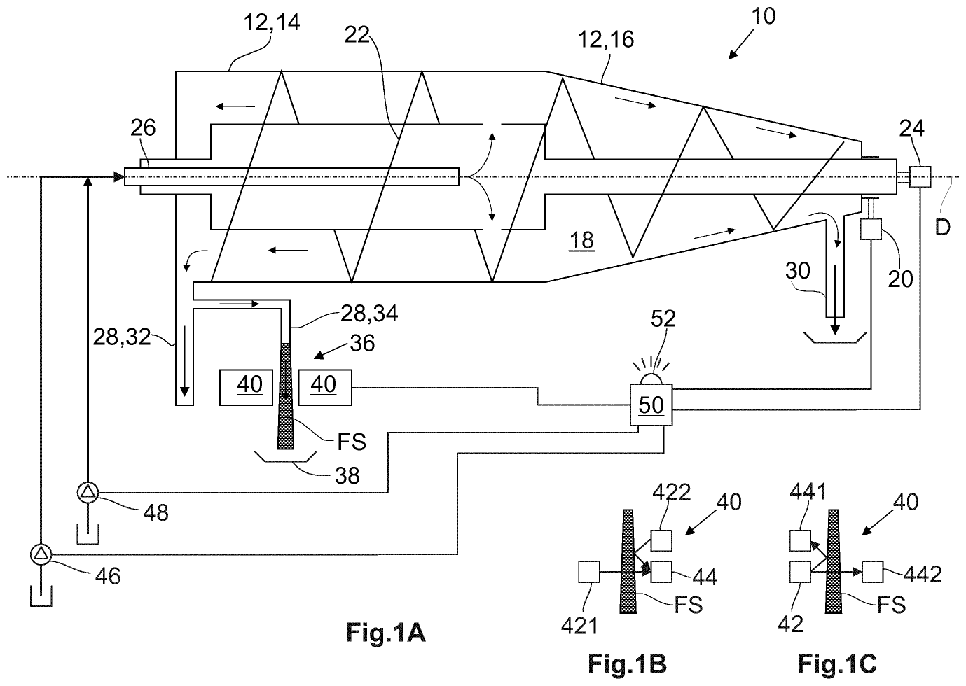

FIG. 1A an embodiment of a device in accordance with the invention;

FIG. 1B a first embodiment of the measurement device;

FIG. 1C a second embodiment of the measurement device;

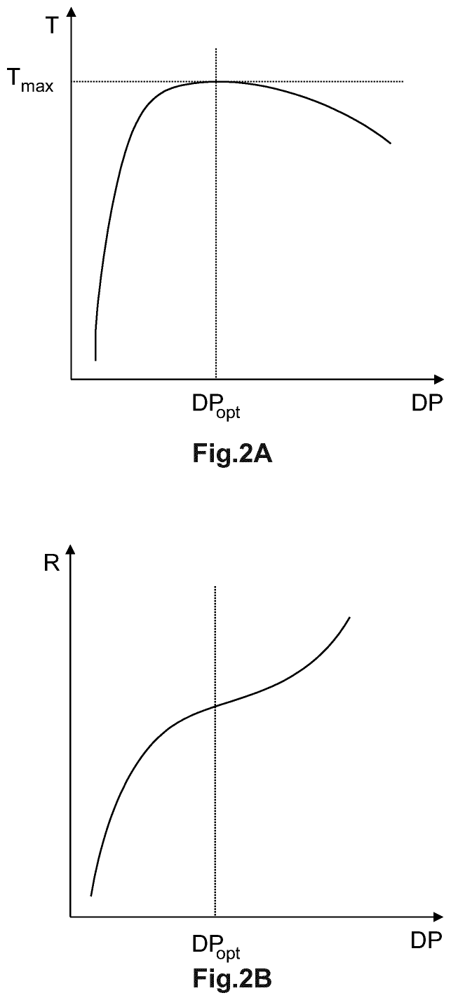

FIG. 2A the curve of the transmission of the centrate as a function of the flocculation agent amount;

FIG. 2B the curve of the reflection of the centrate as a function of the flocculation agent amount;

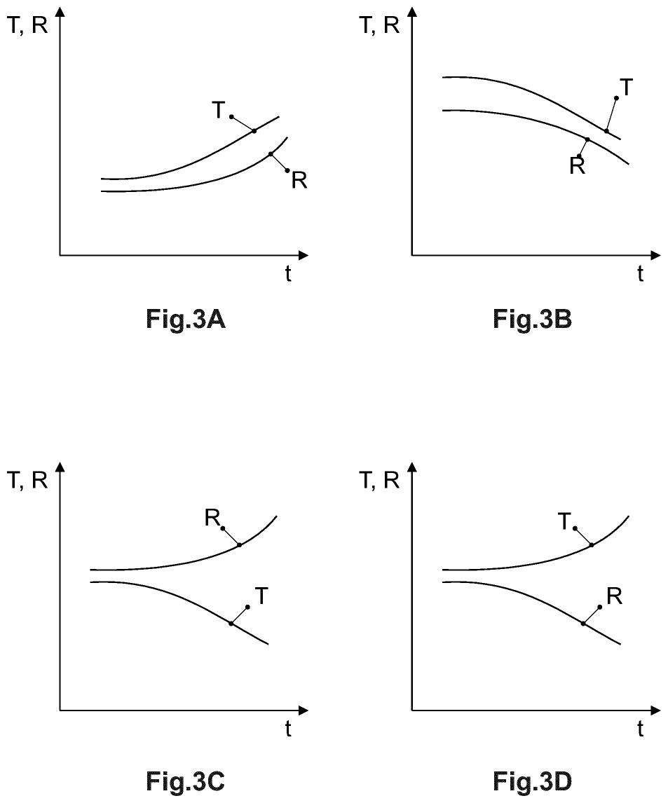

FIGS. 3A different changes of the transmission and of the reflection over to 3D time;

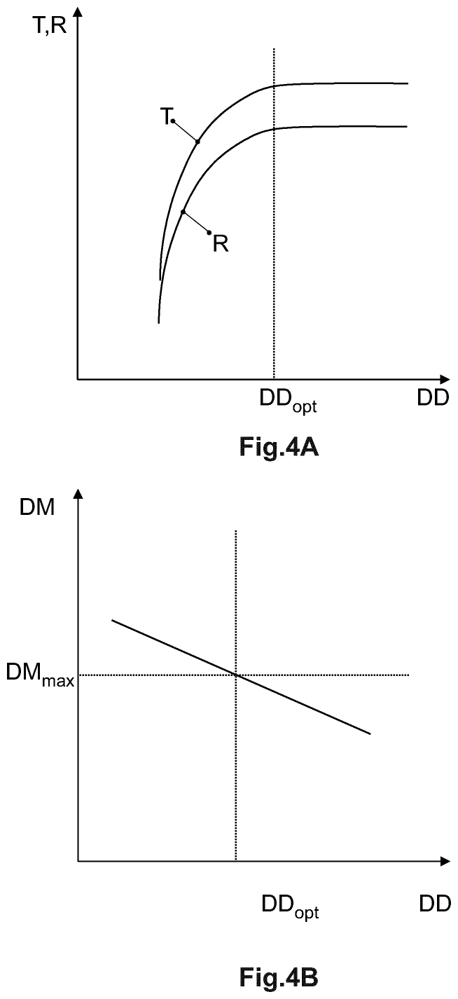

FIG. 4A the curve of the transmission and of the reflection at the centrate as a function of the rotational speed difference; and

FIG. 4B the curve of the conveying torque of the device as a function of the rotational speed difference,

in each case with reference to schematic representations.

FIG. 1 shows an embodiment of a device 10 in accordance with the invention for continuously separating flowable materials of different densities of a suspension with reference to a fundamental representation. Sewage sludge can be used as the suspension, for example. Such devices are also called decanter centrifuges.

The device 10 comprises a drum 12 having a cylindrical section 14 and a frustoconical section 16, with the drum 12 surrounding a hollow space 18 The drum 12 is rotatably supported about an axis of rotation D in a manner not shown in any more detail. To be able to rotate the drum 12 about the axis of rotation D, the device 10 comprises a drum motor 20 that is arranged outside the hollow space 18 and that interacts with the drum 12 in a manner not shown in any more detail.

A screw conveyor 22 that Is likewise rotatably supported about the axis of rotation D in a manner not shown in any more detail is arranged in the hollow space 18. The drum 12 and the screw conveyor 22 are therefore arranged coaxially. The screw conveyor 22 is rotatable about the axis of rotation D by a screw conveyor motor 24, with the manner of the interaction of the screw conveyor motor 34 with the screw conveyor 22 also not being shown in any more detail here. The screw conveyor motor 24 is arranged outside the hollow space 18.

The device 10 further has an inflow pipe 26 with which the suspension can be introduced into the hollow space 18. The device 10 furthermore comprises an outflow 28 for a centrate acquired from the substrate and an outlet stub 30 for a solid acquired from the substrate. While the outflow 28 is arranged in the region of the cylindrical section 14 of the drum 12, the outlet stub 30 is associated with the frustoconical section 16 of the drum 12.

The outflow 28 is divided outside the hollow space 18 into a first outflow section 32 and a second outflow section 34. While the predominant amount of the centrate runs off through the first outflow section 32, a representative partial flow of the centrate flows through the second outflow section 34. The second outflow section 34 has a free jet section 36 in which the centrate forms a free jet FS. The second outflow section 34 has no surfaces in the free jet section 36 that come into contact with the centrate. The second outflow section 34 comprises a funnel 38, for example, downstream of the free jet section 36 by which the centrate can be intercepted and led back into the first outflow section 32 or can be removed in another manner (not shown).

A measurement device 40 is located in the free jet section 36 by which the transmission T and/or the reflection R of the centrate in the free jet section 36 can be measured. For this purpose, the measurement device 40 has either a first light source 421 and a second light source 422 as well as a light receiver 44 (FIG. 1B), for example a photodiode, or a light source 42 and a first light receiver 441 and a second light receiver 442 (see FIG. 1C). The optical path of the light is shown in FIGS. 1B and 1C. With reference to FIG. 1B, the portion of light that, emanating from the light source 421, passes through the free jet FS of the centrate and is received by the light receiver 44 disposed opposite the light source 421 is called the transmission T and the corresponding measurement is called a transmitted light measurement. The portion of light that, emanating from the light source 422, is reflected by the free jet FS and is received by the light receiver 44 arranged on the same side of the free jet FS of the light source 422 is called the reflection R and the corresponding measurement is called a reflected light measurement.

The device 10 comprises a feed pump 46 to be able to introduce the suspension into the hollow space 18. The device 10 is furthermore equipped with a metering pump 48 by which a flocculation agent, for example a polymer, can be introduced into the hollow space 18.

The device 10 furthermore comprises a control unit 50 that processes the data generated by the measurement device 40. The control unit 50 is connected to a transducer 52 that can generate an indication signal, for example in optical or acoustic form. The control unit 50 is furthermore connected to the drum motor 20, to the screw conveyor motor 34, to the feed pump 46, and to the metering pump 48.

The control unit 50 can cause the transducer 52 to generate an indication signal in dependence on the result of the data processing. In addition, the control unit 50 can control the drum motor 20 and the screw conveyor motor 24 such that a first rotational speed of the drum 12 or a second rotational speed of the screw conveyor 22 is changed. The control unit 50 can furthermore control the feed pump 46 and the metering pump 48 such that the flocculation agent amount DP and/or the suspension amount DS, and consequently the concentration of the flocculation agent in the hollow space 18, is changed.

The device 10 is operated in the following manner: The suspension is continuously pumped into the hollow space 18 of the drum 12 by means of the feed pump 46. The drum 12 here rotates at the first rotational speed while the screw conveyor 22 rotates at the second rotational speed. The first rotational speed here determines the amount of the centrifugal acceleration acting on the suspension. The second rotational speed is not the same as the first rotational speed so that a rotational speed difference DD results from the first rotational speed and the second rotational speed. The solids are deposited at the inner surface of the drum wall due to the different densities of the materials contained in the suspension while the liquid centrate is collected due to the smaller density radially within the solids toward the axis of rotation D. A solid-liquid separation is consequently effected. The solids are conveyed by the screw conveyor 22 to the outlet stub 30 and are removed from the drum 12 there. The centrate is removed from the drum 12 via the outflow 28.

The rotational speed difference DD determines the speed at which the solids are conveyed out of the drum 12 and thus the dwell time of the solids in the drum 12. The lower the dwell time, the smaller the water content in the solid phase. The conveying torque DM of the screw conveyor 22 is analog to the solid filling of the drum 12 and can be automatically adapted using the rotational speed difference DD. The minimal rotational speed difference DD is bounded by a maximum permitted conveying torque DMₘₐₓ. In addition, the screw conveyor 22 has to remove at least as many solids from the drum 12 as are supplied to the drum 12; the excess portion of the solids otherwise enters into the centrate.

An effective solid-liquid separation is frequently only possible when flocculation agents are added to the suspension. The flocculation agents do not have any influence on the flock size and thereby on the deposition speed and the deposition behavior of the solids in the centrifugal field. If the deposition speed is too low, the solids cannot be deposited at the inner surface of the drum wall within the short dwell time of the liquid phase in the drum 12 and are partially carried out with the centrate. In addition, the flocculation agents influence the agglomeration of the solids at the drum wall and thus also influence the torque of the screw conveyor 22 and the dry substance content of the removed solid. The addition of the flocculation agent takes place using the metering pump 48.

To be able to operate the device 10 as optimally as possible, the parameters of rotational speed difference DD and flocculation agent amount DP have to be set such that a dry substance content in the solid phase that is as high as possible is achieved and a dry substance content in the liquid phase that is as small as possible is achieved with a simultaneously economic use of the flocculation agents during the total continuously carried out solid-liquid separation. For this purpose, the transmission T and the reflection R determined by the measurement device 40 at the free jet FS of the centrate are evaluated in the following manner:

In FIG. 2A, the transmission T of the centrate is entered schematically as a function of the flocculation agent amount DP. As the flocculation agent amount DP increases, the transmission T increases due to the dropping solid content up to a relative maximum Tₘₐₓ. The centrate has the relatively smallest solid content at the relative maximum of the transmission T. If more flocculation agent is added, the transmission T drops again. The repeated drop in the transmission T is due to a clouding of the centrate due to excess flocculation agent and the bubble formation in the centrate that occurs to an increasing degree on an overmetering of the flocculation agent due to surface active substances in the flocculation agents, in particular with polymers. The flocculation agent amount DP that is added at Tₘₐₓ represents the economically most favorable flocculation agent amount DPₒₚₜ with the minimal achievable solid content in the centrate.

If the device 10 is operated at a constant flocculation agent amount DP and a constant suspension volume flow and if the composition of the inflowing suspension changes over the time t, which is rather the rule than the exception with sewage sludge, the required flocculation agent amount DP also changes to be able to operate the device 10 optimally in the above-described sense. However, the cause of the change cannot be clearly determined from a resulting change of the transmission T. A drop in the transmission T means either an increase in the solid content or an increase in the overmetering of the flocculation agent. An increase in the transmission T means either a drop in the solid content or a drop in the overmetering of the flocculation agent.

In FIG. 2B, the reflection R of the centrate at the free jet FS is entered schematically as a function of the flocculation agent amount DP. The reflection R measured at the free jet FS of the filtrate has, in contrast with the transmission T, a monotonically increasing curve as a function of the flocculation agent amount DP. The reflection R increases up to the optimum flocculation agent amount DPₒₚₜ since the free jet FS of the centrate becomes brighter and brighter due to the decreasing solid content. The reflection R increases again above the optimum flocculation agent amount DPₒₚₜ. This is due to the increasingly milky white coloring of the centrate due to excess flocculation agent and the increasingly occurring bubble formation and the reflection R of the light at these bubbles associated therewith.

If the device 10 is operated with a constant flocculation agent amount DB and a constant suspension volume flow, and if the composition of the supplied substrate and thus also the required flocculation agent amount DR vary over the time t, the cause for the change cannot be clearly determined from a resulting change of the reflection R. A drop in the reflection R means either an increase in the solid content or a drop in the overmetering of the flocculation agent. An increase in the reflection R means either a drop in the solid content or an increase in the overmetering of the flocculation agent.

It is possible in accordance with the invention to evaluate the functions of both the transmission T and the reflection R. As a result, the cause of the changes of both values can be clearly determined during the total continuous operation, which will be explained in more detail with respect to FIGS. 3A to 3D.

If the device 10 is operated with a constant flocculation agent amount DP and a constant suspension volume flow, and if the composition of the inflowing substrate and thus also the required flocculation agent amount DP vary over the time t to optimally operate the device 10, the cause for the change can be clearly determined from a resulting change of the transmission T and the reflection R:
a) If the transmission T and the reflection R increase over the time t, the solid concentration in the centrate drops (FIG. 3A). In other words, the undermetering of the flocculation agent drops.
b) If the transmission T and the reflection R drop over the time t, the solid concentration in the centrate increases (FIG. 3B). In other words, the undermetering of the flocculation agent increases
c) If the reflection R increases and the transmission T drops over the time t, the overmetering of the flocculation agent increases (FIG. 3C).
d) If the transmission T increases and the reflection R drops over the time t, the overmetering of the flocculation agent drops (FIG. 3D).

The evaluation of a transmission and reflection measurement at the representative free jet FS is not only suitable to locate the instantaneously optimum flocculation agent amount DPₒₚₜ, but is also suitable to track the optimum flocculation agent amount DPₒₚₜ during the ongoing operation on a change of the composition of the substrate. The locating of the optimum flocculation agent amount DPₒₚₜ preferably takes place on the basis of relative changes of the detected measured values and is thus independent of randomly predefined absolute desired values as would be necessary with a regulation.

Starting from a set starting rotational speed difference and a set starting flocculation agent amount, an optimum flocculation agent amount DPₒₚₜ is sought and set in a first step with the aid of the above conclusions from the changes of the measured values for the transmission T and for the reflection R.

In a second step of the method, starting from a set staring rotational speed difference and the optimized flocculation agent amount DPₒₚₜ located in the first step, the minimal possible and thus optimum rotational speed difference DDₒₚₜ is sought and set, with the conditions:
a) The solid content in the centrate does not increase or only increases within predefinable tolerances (FIG. 4A); and/or
b) The maximum permitted conveying torque DMₘₐₓ of the screw conveyor 22 is not exceeded (FIG. 4B).

The two steps of the optimization can be carried out by means of heuristic optimization processes. The optimization processes are ended by means of suitable abort criteria.

In a simplest variant, an indication signal can be generated in the case of an undermetering when changes in accordance with FIG. 3B are adopted and predefinable tolerance limits are exceeded or fallen below. Alternatively, an indication signal for an overmetering can be generated when changes in accordance with FIG. 3D are adopted and predefinable tolerance limits are exceeded or fallen below.

In a further variant, the operating parameters of flocculation agent amount DP and/or rotational speed difference DD can be accessed in a corrective manner. If the changes in accordance with FIG. 3B are adopted and if predefinable tolerance limits are fallen below, the flocculation agent amount DP and/or the rotational speed difference DD are increased for so long until the measured values are again above the tolerance limit. The processes for optimizing the flocculation agent amount DP and/or the rotational speed difference DD are then instigated. If changes in accordance with FIG. 3C are adopted and if predefinable tolerance limits are exceeded or fallen below, the flocculation agent amount DP is reduced in a first step and an optimum flocculation agent amount DPₒₚₜ is sought and set. The process of optimization is aborted when the measured values still exceed or fall below the tolerance limits within a predefinable time t.

### REFERENCE NUMERAL LIST

10 device

12 drum

14 cylindrical section

16 frustoconical section

18 hollow space

20 drum motor

22 screw conveyor

24 screw conveyor motor

26 inflow pipe

28 outflow

30 outlet stub

32 first outflow section

34 second outflow section

36 free jet section

38 funnel

40 measurement device

42 light source

421 first light source

422 second light source

44 light receiver

441 first light receiver

442 second light receiver

46 feed pump

48 metering pump

50 control unit

52 transducer p D axis of rotation

DD rotational speed difference

DM conveying torque

DP flocculation agent amount

DS suspension amount

FS free jet

t time

T transmission

R reflection

1. A device for continuously separating flowable materials of different densities of a suspension comprising:
a drum rotatably supported about an axis of rotation, the drum being rotatable about the axis of rotation by a drum motor and surrounding a hollow space;
a screw conveyor rotatably supported about the axis of rotation, the screw conveyor being at least partially arranged in the hollow space and rotatable about the axis of rotation by a screw conveyor motor;
an inflow pipe for supplying the suspension to the hollow space, wherein the drum has an outflow for the removal of a centrate acquired from the suspension from the hollow space, and wherein the outflow section has a free jet section in which the centrate forms a free jet; and
a measurement device by which the transmission and/or the reflection of the centrate in the free jet section can be contactlessly determined.

2. The device in accordance with claim 1, wherein the outflow is divided into a first outflow section and into a second outflow section, and wherein the free jet section is arranged in the second outflow section.

3. The device in accordance with claim 1, wherein the measurement device has at least two light sources and at least one light receiver or at least one light source and at least two light receivers.

4. The device in accordance claim 1, wherein the measurement device has at least one transducer that outputs an indication signal when the change of the determined transmission and/or of the determined reflection exceeds or falls below a specific value.

5. The device in accordance with claim 1, wherein the measurement device interacts with a control unit by which the drum motor and/or the screw conveyor motor are controllable in dependence on the change of the determined transmission and/or the determined reflection.

6. The device in accordance with claim 5, wherein the device comprises:
a feed pump for conveying the suspension into the hollow space through the inflow pipe; and
a metering pump for conveying a flocculation agent into the hollow space,
wherein the feed pump and/or the metering pump are controllable by the control unit in dependence on the determined transmission and/or on the determined reflection.

7. A method of continuously separating flowable materials of different densities of a suspension having the device in accordance with claim 1, said method comprising the following steps:
supplying the suspension to the hollow space through the inflow pipe;
rotating the drum about the axis of rotation by means of the drum motor;
rotating the screw conveyor about the axis of rotation by means of the screw conveyor motor;
removing the centrate acquired from the suspension from the hollow space through the outflow, with the centrate forming a free jet in the free jet section; and
contactlessly determining the transmission of the centrate and/or the reflection by means of the measurement device in the free jet section.

8. The method in accordance with claim 7, said method further comprising the following steps:
rotating the drum about the axis of rotation at a first rotational speed by means of the drum motor;
rotating the screw conveyor about the axis of rotation at a second rotational speed by means of the screw conveyor motor; and
changing the rotational speed difference by means of the control unit in dependence on the change of the determined transmission and/or of the determined reflection.

9. The method in accordance with claim 7, said method further comprising the following steps:
conveying a flocculation agent amount into the hollow space by the metering pump; and
changing the flocculation agent amount by controlling the metering pump by means of the control unit in dependence on the change of the determined transmission and/or of the determined reflection.

10. The method in accordance with claim 7, said method further comprising the following steps:
conveying a suspension into the hollow space by the feed pump; and
changing the suspension amount by controlling the feed pump by means of the control unit in dependence on the change of the determined transmission and/or of the determined reflection.

11. The method in accordance with claim 7, said method further comprising at least one of the following steps:
detecting a reduction of the undermetering in the centrate on a relative increase of the transmission and the reflection; or
detecting an increase in the undermetering in the centrate on a relative drop of the transmission and the reflection; or
detecting an increase in the overmetering of the flocculation agent on a relative drop of the transmission and a relative increase in the reflection; or
detecting a reduction of the overmetering of the flocculation agent on a relative increase of the transmission and a relative drop of the reflection.

12. The method in accordance with claim 7, said method further comprising the following steps:
minimizing the rotational speed difference until the solid content in the centrate does not increase or only increases within predefinable limits and/or the maximum permitted conveying torque of the screw conveyor is not exceeded.

13. The method in accordance with claim 7, said method further comprising at least one of the following steps:
optimizing the flocculation agent amount using the relative change of the transmission and/or the relative change of the reflection; and/or
optimizing the rotational speed difference using the relative change of the transmission and/or the relative change of the reflection.

14. The device in accordance with claim 2, wherein the measurement device has at least two light sources and at least one light receiver or at least one light source and at least two light receivers.

15. The device in accordance with claim 2, wherein the measurement device has at least one transducer that outputs an indication signal when the change of the determined transmission and/or of the determined reflection exceeds or falls below a specific value.

16. The device in accordance with claim 3, wherein the measurement device has at least one transducer that outputs an indication signal when the change of the determined transmission and/or of the determined reflection exceeds or falls below a specific value.

17. The device in accordance with claim 2, wherein the measurement device interacts with a control unit by which the drum motor and/or the screw conveyor motor are controllable in dependence on the change of the determined transmission and/or the determined reflection.

18. The device in accordance with claim 3, wherein the measurement device interacts with a control unit by which the drum motor and/or the screw conveyor motor are controllable in dependence on the change of the determined transmission and/or the determined reflection.

19. The device in accordance with claim 4, wherein the measurement device interacts with a control unit by which the drum motor and/or the screw conveyor motor are controllable in dependence on the change of the determined transmission and/or the determined reflection.

20. A method of continuously separating flowable materials of different densities of a suspension having the device in accordance with claim 2, said method comprising the following steps:
supplying the suspension to the hollow space through the inflow pipe;
rotating the drum about the axis of rotation by means of the drum motor;
rotating the screw conveyor about the axis of rotation by means of the screw conveyor motor;
removing the centrate acquired from the suspension from the hollow space through the outflow, with the centrate forming a free jet in the free jet section; and
contactlessly determining the transmission of the centrate and/or the reflection by means of the measurement device in the free jet section.
